(19) United States
(12) Patent Application Publication
(10) Pub. No.: US 2008/0071745 A1
(43) Pub. Date: Mar. 20, 2008

(54) WEB BASED TELEPHONY ACCESS METHOD

(76) Inventor: Richard Lloyde Clarke, Macclesfield (AU)

Correspondence Address: STRAUB & POKOTYLO, 620 TINTON AVENUE, BLDG. B, 2ND FLOOR, TINTON FALLS, NJ, 07724, US

(21) Appl. No.: 11/576,465

(22) PCT Filed: Oct. 5, 2005
(86) PCT No.: PCT/AU05/01519

§ 371 Date: Apr. 1, 2007

(30) Foreign Application Priority Data
Oct. 5, 2004 (AU) 2004905700

(51) Int. Cl. G06F 17/30

(52) U.S. Cl. 707/3

(57) ABSTRACT

A system and apparatus are disclosed that facilitate a person (an end user) making a telephone call to another person or a service (for example a mobile service provider) by the end user clicking on a representation of a telephone number or other telephony identifier that is sourced from any data base by the end user or a third party. The system and apparatus include the ability to convert a telephony identifier into an end user actionable action initiator, that may be a hyperlinked telephone number or an icon. Once the action initiator is initiated the end user is provided a telephony connection, by the device used by the end user or a third party makes the telephony connection, between the end user's device and the mobile service provider's device. Various telephony technologies can be used to make the connection including the Plain Old Telephone System (POTS), Voice over Internet Protocol (VoIP) and many others or combinations of two or more of them.

This invention relates to the field of telecommunications and in particular to the provision of a system and a service that facilitates a person making a telephone call to another person or a service by clicking on a representation of a telephone number that is sourced from any data base.

### BACKGROUND

Commonly, businesses and persons (a wanted target) make a variety of contact details available in computer files (such as a telephony contact identifier in a WEB page) that are made accessible to persons (users) using the world wide network of computer commonly referred to as the Internet. Businesses also arrange for their contact details, typically a telephone number, to be included in paper based business and telephone directories and include an Internet WEB page address.

When such details include a telephone number it is expected that the person seeking to contact them will, having located the telephone number, call them using their telephony service of choice.

Currently, there are a variety of telephony services that can be used by persons wishing to create a telephonic connection with others. The most common is the Plain Old Telephone Service (POTS) also known as the PSTN (Public Switched Telephone Network) that requires users to pick up a telephone handset and dial a telephone number to effect a switched connection using wire and wireless technologies. As with most telephonic services the connection is not restricted to audio only and depending on the devices at each end of the connection visual and data exchange can occur between the users at each end.

Alternative telephony services currently available include cellular telephone systems (Cell Phones) which are primarily an alternative to and in some cases an extension of the POTS, and Voice over Internet Protocol (VoIP) which is also an alternative to the POTS. The VoIP alternative involves the execution of a software application installed on the user's computer device. The execution of the application includes a predetermined sequence of steps, including the operation (clicking) of a pointing device over an initiating icon (shortcut) or similar artifact on the user's computer device, the action sometimes referred to as a click-dial although many modes of actuation exist. The user's computer device is then directed to create a connection between an Internet Address to another Internet Address and using Internet Protocol deliver and receive voice signals via the Internet to and from the wanted person's computer device. If required the connection can enter the POTS or alternative telephony services and connect to the wanted person's POTS business telephone or a computer that can receive and deal with a VoIP connection. The Internet is used at least as part of the communication path by utilizing Transmission Control Protocol/Internet Protocol (TCP/IP). In some instances the PSTN will need to be entered to complete the connection to the wanted person as well as using the Internet computer network.

A telephony contact identifier as listed on a WEB site or in a paper based directory could be a telephone number as commonly used in POTS or PSTN systems; a string of characters and/or numbers often used in VoIP systems; a small group of alphanumeric characters and/or just numbers such as are used for speed-dialing or abbreviated-dialing; or it could be an icon that represents a string of data that provides the required identifier for achieving a contact over a respective appropriate telephony network. The Internet is a conveniently accessible repository of information including the contact details of businesses and people.

The typical approach to finding and making contact with people and businesses using the Internet, is to use a browser program that executes on a computer device that has a connection to the Internet. The browser program orchestrates access of the computer to the Internet and provides audio, visual and data presentations obtained from a dedicated WEB server back to the computer user using the vast array of computers referred to as the Internet.

In the case of obtaining information containing contact details for persons or a business there are many WEB servers that collate and make available for searching via the Internet, the contact details of that type of information. Examples of well known Internet accessible directories include, GOOGLE™, the Electronic White Pages™ and Electronic Yellow Pages™. There are paper based equivalents of some of these directories as well.

The invention described herein seeks to provide an alternative way for a user to initiate and to have provided to them a telephony contact with a business or person of interest.

### BRIEF DESCRIPTION OF THE INVENTION

In a broad aspect of the invention a telephony contact identifier conversion system that enables a user to initiate telephony contact between the user and a target using a connection between a user device and target device includes, a conversion application that receives a telephony contact identifier associated with a target and converts the telephony contact identifier into an action initiator and presents the action initiator to a user, wherein the action initiator is adapted to initiate a telephony connection between the user device and the target device.

In an aspect of the invention the telephony contact identifier is a telephone number of a target.

In another aspect of the invention the conversion application executes on the user device.

In a further aspect of the invention the conversion application executes on a device that is not the user device that is adapted to communicate with the user device to facilitate user activation of the action initiator and wherein the conversion application executes on a third party computer server.

In an aspect of the invention the action initiator is provided to a user of the user device as an actionable hyperlink to a target device or as an actionable hyperlink of a telephone number of a target device actionable by the user device when the user initiates the action initiator.

In yet a further aspect of the invention the action initiator is provided to a user of the user device as an actionable user device telephone dialer function actionable by the user device when the user initiates the action initiator, or when the user device has a telephone function the telephone dialer function on the user device creates a telephony connection between the user device and the target device when the user initiates the action initiator.

In another aspect of the invention the action initiator is provided to a user of the user device as an actionable code executable on the user device when the user initiates the action initiator, wherein the code creates a telephony connection between the user device and the target device when the user initiates the action initiator, or where the user device has a telephone function the actionable code executes on the user device to create a telephony connection between the user device and the target device when the user initiates the action initiator.

In another aspect of the invention wherein the action initiator is a user actionable code executable on a device that is not the user device and the user actioned code creates a telephony connection between the user device and the target device, or the code executes on the user telephone to create a telephony connection between the user telephone and the target device or where the device that is not the user device is a telephony server or a WEB server.

In yet another aspect of the invention the telephony connection is formed by connecting the two separate connections or where the two separate connections include a connection between the user device or telephone and the computer server and the computer server and the target device.

In an aspect of the invention the telephony connection includes connections using a public switched telephone network or a cellular telephone network or a Voice over Internet Protocol telephone network or a combination of the use of two or more telephone network uses. In an aspect of the invention the telephony contact identifier conversion system further includes a third party application which executes on a device that is not the user device and that receives data from the user device relating to search criteria created by the user, wherein the third party application conducts a search for targets based on the search criteria in one or more databases, and having located one or more data sets matching the search criteria, communicates one or more telephony contact identifiers associated with the one or more targets to the conversion application.

Specific embodiments of the invention will now be described in some further detail with reference to and as illustrated in the accompanying figures. These embodiments are illustrative, and not meant to be restrictive of the scope of the invention. Suggestions and descriptions of other embodiments may be included within the scope of the invention but they may not be illustrated in the accompanying figures or alternatively features of the invention may be shown in the figures but not described in the specification.

### BRIEF DESCRIPTION OF THE FIGURES

FIG. 1 depicts a display of information for guiding a user wishing to make a telephony contact with a target person or business;

FIG. 2 depicts a system arrangement according to an aspect of the invention where the third party assists in searching for telephony contact identifiers of targets;

FIG. 3 depicts a display of information containing a display of action initiators that can when actioned connect a user to a target;

FIG. 4 depicts a display of information for guiding a user to make a telephony contact with a target person of business;

FIG. 5 depicts a system arrangement according to an aspect of the invention where a conversion application converts telephony contact identifiers on-the-fly and a third party assists in creating a telephony contact identifiers of targets;

FIG. 6 depicts the steps according to an aspect of the invention where the third party assists in searching for telephony contact identifiers of targets;

FIG. 7 depicts the steps of a search function performed by the third party assisting a user in searching for telephony contact identifiers of targets;

FIG. 8 depicts the steps of an alternative search function to that depicted in FIG. 7 performed by the third party assisting a user in searching for telephony contact identifiers of targets;

FIG. 9 depicts the steps according to an aspect of the invention where the user device creates the contact between the user device and the target device; and

FIG. 10 depicts the steps according to an aspect of the invention where the third party creates the contact between the user device and the target device.

### DETAILED DESCRIPTION OF EMBODIMENTS OF THE INVENTION

Embodiments of the invention to be described herein involve a number of technologies including computer programming and telephony engineering. The programming involves data conversion, mobile phone and WEB applications, and the telephony arrangements involve interfacing users to the POTS as well as other telephony services (wired and wireless), a computer communication application that provides Voice over IP, and Internet server arrangements to accommodate a variety of telephony delivery devices, systems, communication protocols and communication carriers.

When the term telephony is used in this specification it does not refer exclusively to audio communication and may include all forms of communication between humans including but not limited to audible, visual, haptic, and olfactory and also includes the communication of information, in most cases digital data from a device used by one person to another device used by another person.

Telephony is used synonymously with the term telecommunications and includes the use of various wired and wireless communication technologies. Technology supporting telecommunications systems advance daily in complexity, convenience and cost and the term telephony should not be limited by way of the technology supporting it.

There are a number of possible embodiments all of which support a user that wishes to communicate or deal with another person (also referred to herein as the target) that can provide a product or service to the user at the location the user is at or a location nominated by the user. The embodiments described herein all provide to the user an action initiator that is adapted to initiate a telephony connection between a device used by the user and a device used by the target.

The first embodiment to be described in detail herein and depicted in one embodiment in FIG. 2, involves the use of a third party service provider (a party separate from the user and mobile product and service provider(s)) from which users subscribe the provision of a service that converts telephony contact identifiers into an action initiator operable by the user on their preferred user device. User devices may include but are not limited to a personal computer, a personal digital assistant (PDA), a mobile telephone or such like device.

The third party service includes converting a telephony contact identifier associated with the mobile service provider such as a telephone number into an action initiator. In fact it is the way in which the telephony contact identifier is obtained which highlights the main difference between two of the embodiments presented herein.

In a first embodiment the user obtains the telephony contact identifier by whatever means is at their disposal and supplies the telephony contact identifier to the third party.

In a second embodiment the third party obtains the telephony contact identifier based on a search criteria provided to it by the user. In each case the third party, also as part of its service, converts the telephony contact identifier into an user actionable action initiator and supplies it to the user for action at their discretion.

In another embodiment it is the user that identifies a particular telephony contact identifier associated with a product of service provider and it is a user device such as their mobile telephone and a software program that converts the telephony contact identifier into an action initiator actionable by the user at their discretion.

In all embodiments of the invention the action initiator is adapted to initiate a telephony connection between the user device and the target device.

A user desiring to use a third party service will need to register with that third party service provider. The details that the person provides may, by way of example, include their name, billing details and a list of one or more telephony contact numbers that they can be communicated with.

way of example, include their name, billing details and a list of one or more telephony contact numbers that they can be communicated with.

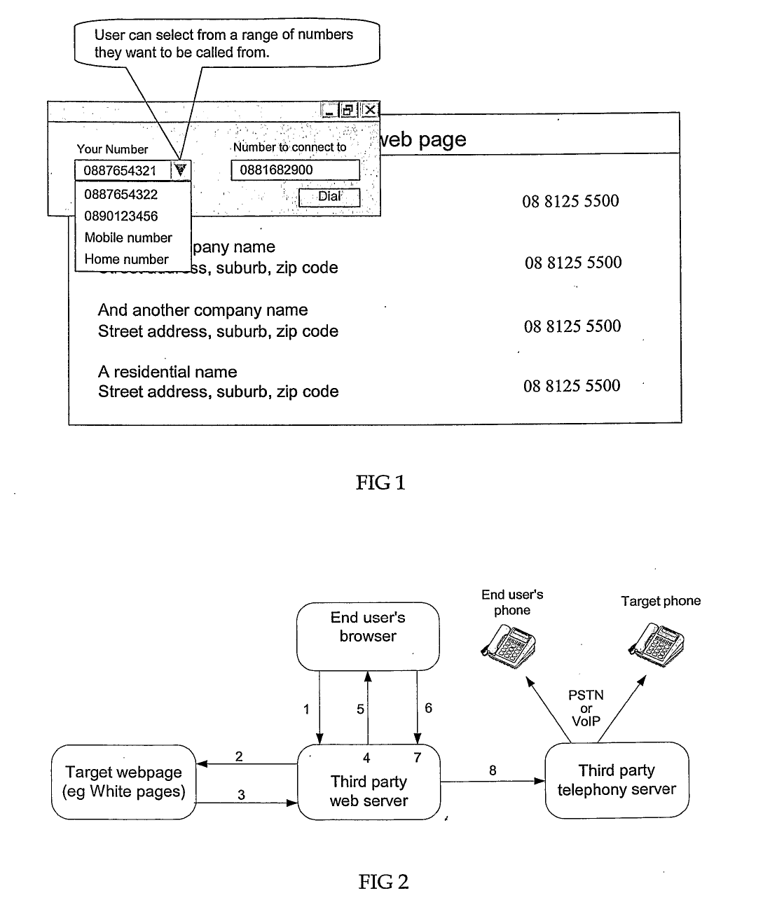

The user telephony contact numbers may, by way of example, be a POTS telephone number or it may be a VoIP address or unique VoIP identifier or may even be a mobile (Cell) phone number. The provision of those contact details is not mandatory as there are many other types of contact related identifiers that could be nominated by the user which may for example depend on the type of telephony adapted device they are using. The order of the list can be predetermined by the user so the service provider knows what number is the most likely to be useful when arranging a telephony connection involving that user. That same order or another order may be used for presentation of a list to the user (in a drop-down format) if the user needs or wants to designate a different contact number for being contacted at the time as depicted by way of example in FIG. 1 as seen by the user. Alternatively the user can decide to have the system default to a particular telephony number at any given time so that they can action a true one-click-dial.

The third party service can operate in a number of ways, some of which will be described below.

FIG. 2 depicts the third party service provider receiving a request 1 from the user's browser to view a particular WEB page such as a business directory or any web page that may display a telephony number (e.g. White Pages™ listing) that can be used to contact a product or service provider. The requested WEB page 2 is obtained 3 by the third party and processed to identify all the telephony contact identifiers and convert them into action initiators as will be described later in this specification. The modified WEB page, a simple example of which is depicted in FIG. 3, is then passed back to the user including none, one or more action initiators 5. In the example depicted in FIG. 3, four listings have been provided along with four corresponding action initiators in the form of hyperlinked POTS telephone numbers.

The user then views actionable action initiators that can be actioned by the user at their discretion 6. The third party WEB server receives 7 the action instructions and facilitates a telephony connection 8 between the user's device and the target device so as to permit telephony communication between the user and the target. The telephony connection is handled in this embodiment by a third party controlled telephony server that can use one or more of the telephony mediums available between the user's nominated telephony contact identifier and the target's telephony contact identifier, which is shown as a POTS (PSTN) connection or a VoIP connection by way of example.

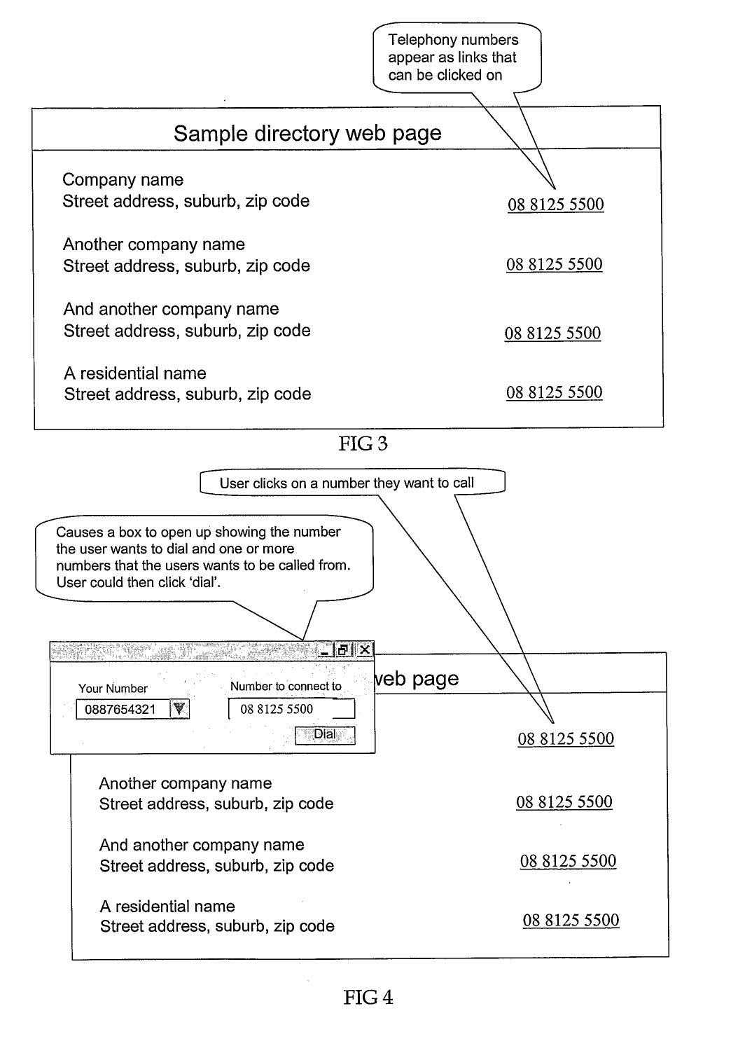

FIG. 4 depicts a slight variation of the above procedures involving the provision by the third party WEB server of an actioning window that is used by the user to both nominate the telephony contact they want to use to contact them and also clearly identifies the telephony contact identifier they want to contact, which is created by the user simply clicking their pointing device icon over a selected hyperlinked telephone number associated with the desired target. In the example depicted the additional dial button is provided but in other embodiments the single click of the action initiator being a hyperlinked telephone number is enough to actuate the telephony connection being made.

In yet a further variation the user can download and use a client program or WEB browser plug-in or some other such executable program, that enables the user's own browser or telephony contact identifier viewer program and device to firstly identify telephony contact identifiers that are displayed and convert them into actionable action initiators. Importantly for the user in this variation there is no need for the plug-in to communicate the page details or identifying details of the user during the conversion process. The conversion process is totally self-contained and done in real time (on-the-fly).

A telephone number can be straightforwardly used to make a connection but a telephony identifier could be a contact number that receives audio messages or has an automatic voice recognition responder facility or that enables a voice connection over the Internet. Such services are not commonplace but it is envisaged that in time there will be telephony contact identifiers that enable such services or other services that are different from the typical phone experience.

Ultimately all the telephone numbers and telephony identifiers are identified and provided to the user preferably without the user realizing that there have been a number of processes performed.

In one embodiment, modified WEB pages are presented to the user with replacements for each of the telephone numbers/telephony contact identifiers thereon. The telephone numbers are represented, in one example, as an icon or action initiator identifier and may or may not be in exactly the same location they originally were located on that WEB page but represented so as to be readily visible to the user as a clickable icon. The icon or identifier created by the modification process, and hereinafter referred to as a action initiator, can be represented to the user viewing the WEB page as a Hyperlink e.g. 08 8125 5500 which is a form of clickable representation familiar to WEB page users. Examples of this are depicted in FIGS. 3 and 4.

Hyperlinks are elements of an electronic document that are embedded in the electronic code of the document that are associated with a link to another place in the same document or to an entirely different document that is typically located on the WEB. Typically, the user clicks on the hyperlink to follow the link. Hyperlinks are an essential element of all hypertext systems, that includes the World Wide Web.

In one embodiment the target web page has already been modified so that the telephony numbers are already displayed as phone-links, in this case the user clicks on the action initiator to initiate a telephony communication and a third party server at some point in the network acts on this request and carries out the requested telephony communication task or the user device creates the connection itself.

Once the telephone number or telephony terminal identifier is modified, the user can initiate a process that creates a telephony connection between the user and the target.

The telephony connection could work in many ways. In one example, the target that makes its telephony contact identifier available on the WEB page can carry the cost of a third party (the third party that they have previously registered with) calling the target telephone number as well as the cost of the third party calling the user so as to complete the connection. This arrangement would require the third party to provide such a service based on the information provided by the user when they registered for the service. Further details of the arrangement will be described later in the specification.

Another way is for telephony service providers to entice users to subscribe to their telephony or Internet or other such services, where the offering includes free or low cost calls where calls from the user to a target number are within or partially within the service provider's network. This arrangement is anticipated to become a standard feature of service providers offering voice over DSL and other Internet telephony offerings.

Another way is for the person or business that is listed on the WEB page to carry the cost of the call from the third party to themselves and may or may not include the cost of the call from the third party to the person trying to contact them. This approach will thus encourage WEB users to make telephony contact with persons and businesses at the time they are looking at a WEB page of interest because they do not have to incur any cost, or only incur minimal cost in doing so. Clearly, in the later arrangement the user will need to provide their preferred telephone contact at the time but would not need to download any client software. The rest of the process will be automated and result in the two parties being connected to each other. If the WEB user is registered with the third party service provider the requisite preferred telephone information will already be available.

FIG. 1 depicts a window, in this case slightly overlaying the original WEB page display that is used for organising the action of connection between the user and the target. The arrangement of the additional window is typically determined by the defaults of the service or defaults of the computer device. However, depending on the program controlling this window generation step, the new window can be positioned at any location on the user's computer monitor visible area. The telephone number desired to be contacted by the WEB page user is indicated in the field below the heading “Number to Connect to”, thus providing confirmation to the user that the appropriate number has been indicated by their previous click of the action initiator on the amended WEB page.

A further way of choosing the appropriate telephone number is for the service to be aware of the user's presence on a network or be aware of the user's location and use that information to enable the service to provide the one or more telephone numbers, predetermined by that user, back to the user's browser and then displays them in the new window.

A further way of choosing the appropriate telephone number is to use the plug-in to send a unique identifier related to the user and with that information the service provider's equipment provides the one or more telephone numbers, predetermined by that user, back to the user's browser or plug-in and then displays them in the new window.

A yet further way of choosing the appropriate telephone number is to have the user's browser or plug-in access a file or table containing the appropriate telephone numbers that are located on the user's computer device. The browser or plug-in then communicates the selected contact number to the third party service provider.

For the user, the embodiments described above provide convenience, time saving, avoid the need to manually enter phone numbers into a telephony device to dial, avoid making number errors when manual dialing and also avoid the need to manually enter a number into an address book for later use.

It is preferably a further function of the third party service to interface the called numbers into a contact list usable by the user, which can either be the user's own contact list program or a list used only by the third party service at a future time. For disabled users the ability to dial any number in the world with one click will be possible using the above embodiments or those described below.

The third party service provider has a number of advantages to offer to businesses as well as telephony contact directory providers, as they can both align the provision of their service to one or more preferred telephony service providers and can generate new revenue streams for those telephony service providers as well as themselves, and also increase the marketability of directories and websites.

A yet further payment arrangement could involve the end user paying for a standard phone call, i.e. whatever they would have paid had they manually dialed the number (e.g. local, long distance, 1800 free-call etc). To the ad hoc user the benefit is reduced time, effort and errors to access a desired business contact number. However, in this embodiment the cost of the call to the business is borne by the telephone directory service. In this way the directory service creates customer loyalty to their directory service plus attracts subscribers from competitors.

In a further variation the user does not need to make a call using the POTS as they may already have a VoIP facility. Thus the conversion services provided by way of a user executable program or as provided by a third party service provider works much the same way as described above but there is no call costs as the VoIP call may not need to use an external telephony network if that business is also using VoIP. In this arrangement the third party service provider may still be involved because they can interface between the user and the target business by performing a packet switching service at IP level. The previously described computer device controlled by the third party would control this process and provide it as part of the user subscription service as well as the target business subscription service. In such an arrangement existing VoIP service providers can add value to their service by performing the conversion of telephony contact identifier into an action initiator and be involved in the connection between the user device and the target device.

Second tier carriers may be more interested in this later arrangement as they will be eager to acquire increased telephony traffic for their own systems and loyalty from their current subscribers.

Yet a further way of implementing the system is for a directory provider to make changes to their own WEB site by embedding into selected telephony contact identifiers such as telephone numbers an action initiator actionable by users accessing the WEB pages of the directory. The embedded code of action initiator includes a link to the third party service provider that coordinates the making of the two calls, one to the user requesting the connection and the other to the business wanted to be contacted by the user. This arrangement is depicted in FIG. 5. This arrangement requires the involvement of the directory provider but has the advantage that if the user is not a registered user of a third party service provider, then they can be queried by the third party service provider for their preferred telephone contact number and then connected to the target person or business. Thus the directory provider has created a feature that makes its directory customers more loyal especially if the directory were to fund the cost of the calls or alternatively, they can offer the feature as an added cost option to businesses that use their directory.

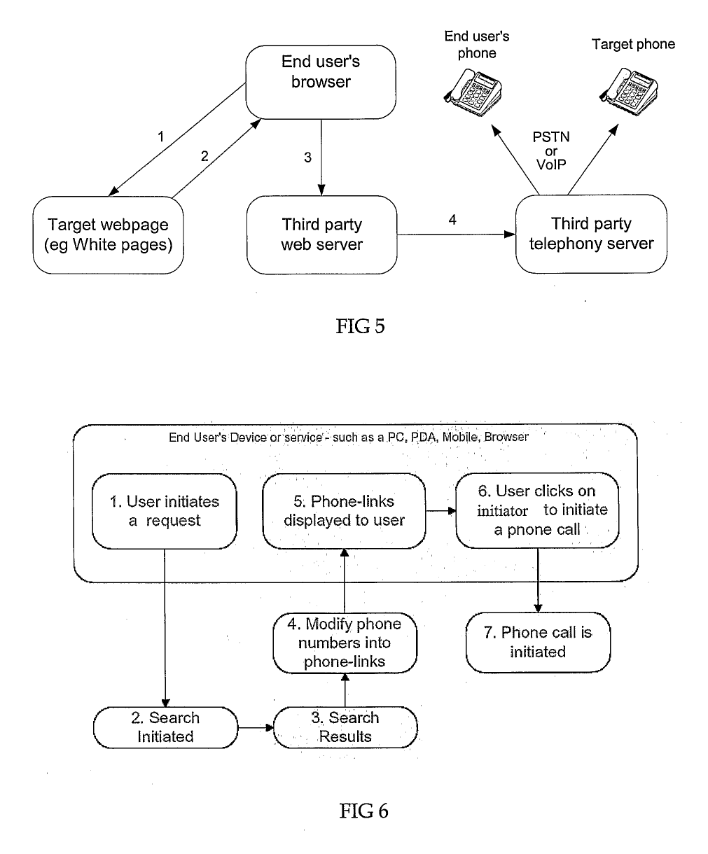

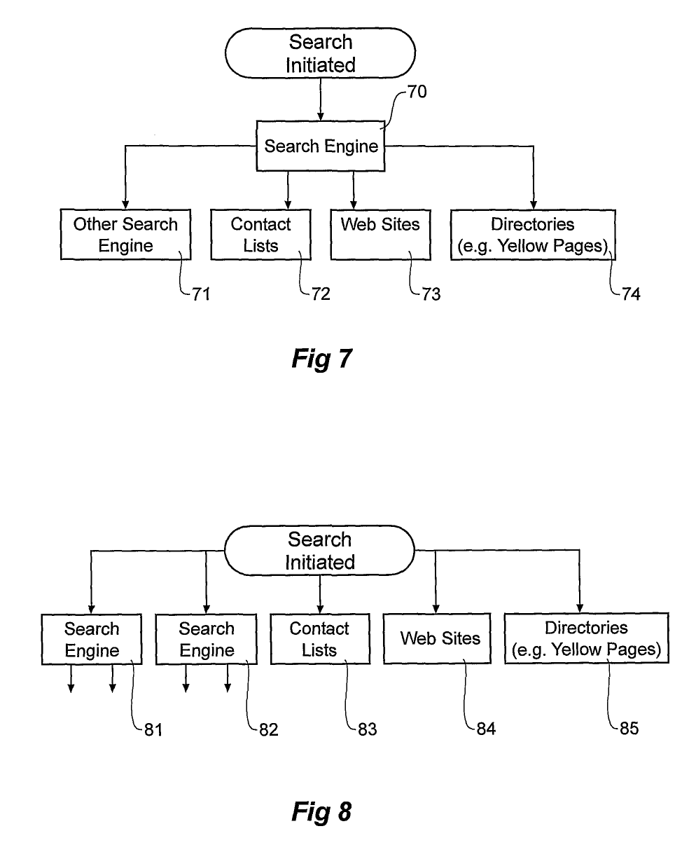

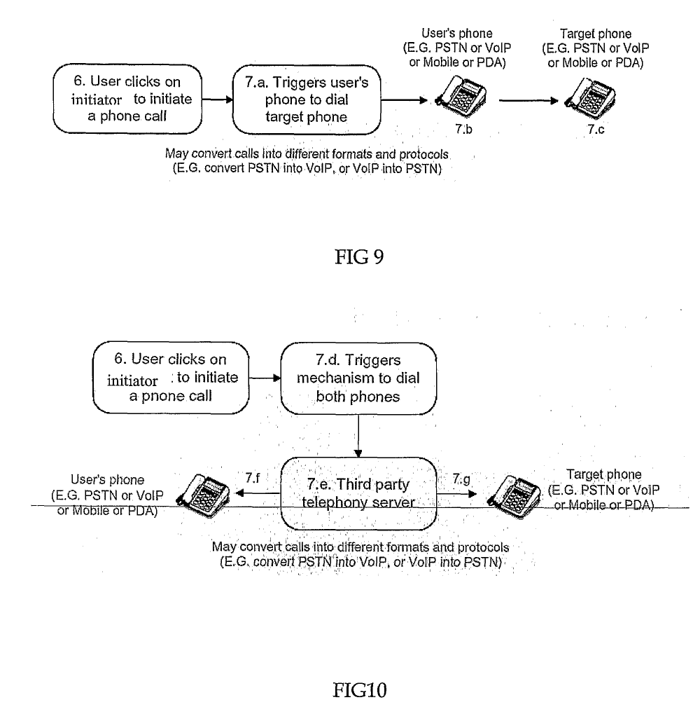

FIG. 6 depicts the flow of actions in an arrangement of a yet further aspect of the invention wherein the user creates 1 on their user device a request to locate and identify the telephony contact details of a target and a third party service provider server receives that request, performs a search 2 according to the search criteria and locates one or more results. The search could be conducted in a number of ways, two of which are depicted pictorially in FIGS. 7 and 8 by way of example only and which will be described in greater detail later in the specification and the results 3 are then available in the form of one or WEB pages containing telephony contact identifiers such as for example telephone numbers. The third party service includes a conversion application that receives one or more telephony contact identifiers associated with the results of the search that are likely to be related to telephony contact identifiers for the one or more targets and converts 4 them into action initiators and makes them available 5 to the user for use at their discretion. Once an action initiator is actioned 6 the third party service provider creates the connection between the user device and a target device to facilitate a telephony connection between the user and the target or the user device can facilitate the connection itself as is depicted in FIGS. 9 and 10 which are pictorial representations of the various actions performed.

FIG. 7 depicts a search process wherein a dedicated search engine 70 is programmed to conduct a search using appropriate syntax in one or more databases including but not limited to other search engines 71, contact lists 72, WEB sites 73 and telephony contact identifier directories 74.

limited to search engines 81 and 82, contact lists 83, WEB sites 84 and telephony contact identifier directories 85.

In FIG. 9 when the user actions the action initiator 6, one way being the clicking of a cursor over the representation of the action initiator, the user device begins the process 7a of creating a telephony connection between the user 7b and the target 7c. If the user device is a telephone then the action is a simple one whereas if the user device is a PDA with a telephony device associated with it, then the device works together to create the connection. If the user device is a personal computer there are number of possible ways for the connection to be made, in one example if VoIP is available then the relevant program is initiated. In another example if the computer device has a TAPI or Telephony Application Programming Interface is a standard that allows computer programs to talk to telephone devices, such as modems or PBX (Private Branch Exchanges) and other telephony devices, then the action initiator works with TAPI to create the telephony connection.

In FIG. 10 when the user actions the action initiator 6, the user device triggers 7d one of a number of actions including the sending of data to a third party service provider that can create a telephony connection between the user device 7f or a predetermined user telephony device and the target telephony device 7g using one or more telephony communication systems including but limited to a POTS telephony connection, a PBX telephony connection, a VoIP telephony connection, etc.

It will be appreciated by those skilled in the art that the invention is not restricted in its use to the particular application described. Neither is the present invention restricted in its preferred embodiment with regard to the particular elements and/or features described or depicted herein. It will be present invention restricted in its preferred embodiment with regard to the particular elements and/or features described or depicted herein. It will be appreciated that various modifications can be made without departing from the principles of the invention. Therefore, the invention should be understood to include all such modifications within its scope.

The claims defining the invention are as follows:

1. A telephony contact identifier conversion system that enables a user to initiate telephony contact between the user and a target using a connection between a user device and target device including:
a conversion application that receives a telephony contact identifier associated with a target and converts the telephony contact identifier into an action initiator and presents the action initiator to a user, wherein the action initiator is adapted to initiate a telephony connection between the user device and the target device.

2. A telephony contact identifier conversion system according to claim 1 wherein the conversion application executes on the user device.

3. A telephony contact identifier conversion system according to claim 1 wherein the conversion application executes on a device that is not the user device that is adapted to communicate with the user device to facilitate user activation of the action initiator.

4. A telephony contact identifier conversion system according to claim 3 wherein the conversion application executes on a third party computer server.

5. A telephony contact identifier conversion system according to claim 1 wherein the telephony contact identifier is a telephone number of a target device.

6. A telephony contact identifier conversion system according to claim 1 wherein the telephony contact identifier is a Voice over Internet Protocol address of a target.

7. A telephony contact identifier conversion system according to claim 1 wherein the telephony contact identifier is an actionable icon representative of a telephone number of a target device.

8. A telephony contact identifier conversion system according to claim 1 wherein the action initiator is provided to a user of the user device as an actionable hyperlink to a target device.

9. A telephony contact identifier conversion system according to claim 1 wherein the action initiator is an actionable hyperlink of a telephone number of a target device actionable by the user device when the user initiates the action initiator.

10. A telephony contact identifier conversion system according to claim 1 wherein the action initiator is provided to a user of the user device as an actionable user device telephone dialer function actionable by the user device when the user initiates the action initiator.

11. A telephony contact identifier conversion system according to claim 10 wherein the user device has a telephone function and the telephone dialer function on the user device creates a telephony connection between the user device and the target device when the user initiates the action initiator.

12. A telephony contact identifier conversion system according to claim 11 wherein the user device is a wireless telephone and the telephone dialer function on the user device creates a telephony connection between the user device and the target device when the user initiates the action initiator.

13. A telephony contact identifier conversion system according to claim 1 wherein the action initiator is provided to a user of the user device as an actionable code executable on the user device when the user initiates the action initiator wherein the code creates a telephony connection between the user device and the target device when the user initiates the action initiator.

14. A telephony contact identifier conversion system according to claim 13 wherein the user device has a telephone function and the actionable code executes on the user device to create a telephony connection between the user device and the target device when the user initiates the action initiator.

15. A telephony contact identifier conversion system according to claim 1 wherein the action initiator is a user actionable code executable on a device that is not the user device wherein the user actioned code creates a telephony connection between the user device and the target device.

16. A telephony contact identifier conversion system according to claim 15 further including:
a user telephone wherein the code executes on the user telephone to create a telephony connection between the user telephone and the target device.

17. A telephony contact identifier conversion system according to claim 15 wherein the device that is not the user device is a telephony server.

18. A telephony contact identifier conversion system according to claim 15 wherein the device that is not the user device is a WEB server.

19. A telephony contact identifier conversion system according to claims 15 and 16 wherein the telephony connection is formed by connecting the two separate connections.

20. A telephony contact identifier conversion system according to claim 19 wherein the two separate connections include a connection between the user device or telephone and the computer server and the computer server and the target device.

21. A telephony contact identifier conversion system according to claim 1 wherein the telephony connection includes connections using a public switched telephone network or a cellular telephone network or a Voice over Internet Protocol telephone network or a combination of the use of two or more telephone network uses.

22. A telephony contact identifier conversion system according to claim 1 further including:
a third party application which executes on a device that is not the user device and that receives data from the user device relating to search criteria created by the user, wherein the third party application conducts a search for targets based on the search criteria in one or more databases, and having located one or more data sets matching the search criteria, communicates one or more telephony contact identifiers associated with the one or more targets to the conversion application.

23. A telephony contact identifier conversion system according to claim 22 wherein the user is validated to communicate search criteria to the third party application.

24. A telephony contact identifier conversion system according to claim 23 further including:
a server application that executes on the device on which the third party application executes and that is used to receive data from the user device and communicate data to and from databases that may contain data relating to a target.

25. A telephony contact identifier conversion system according to claim 22 wherein the conversion application and the third party application communicate using a computer network.
